(19) United States
(12) Patent Application Publication
(10) Pub. No.: US 2007/0136082 A1
(43) Pub. Date: Jun. 14, 2007

(54) System and method for energy diversion investigation management

(75) Inventors: Gregory Allen Jackson, Fayetteville, GA (US); Luella Brown, Decatur, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Southern Company Services, Inc.

(21) Appl. No.: 11/304,164

(22) Filed: Dec. 14, 2005

(51) Int. Cl. G06Q 99/00

(52) U.S. Cl. 705/1; 705/412

(57) ABSTRACT

A method, system and program product for managing energy diversion investigations. An energy diversion case is identified and case information is entered into an energy diversion investigation application. The data entered into the application is automatically accumulated and stored in an energy diversion investigations database. An energy diversion case file is generated and updated by an investigator assigned to the energy diversion case. The energy diversion case file can include case information, condition found, people involved in the energy diversion case, cost and recovery information, legal action taken and account information regarding the premises for which the investigation is being conducted. A revenue protection component determines a cost and a recovery amount associated with the energy diversion case. A report component generates predefined or custom reports for management and analysis.

### BACKGROUND OF THE INVENTION

Stealing electricity from a utility is a common problem that all utilities face. It is estimated that theft of electricity cost utilities billions of dollars annually, with these losses generally being passed on to utility customers in the form of higher rates. Tampering with an electric meter can render it unsafe and unstable. The offenders not only put themselves at risk, but also any neighbors, children or pets in the area are in danger of electric shock, power surges and fires from the 240 volts that are exposed. Emergency utility personnel called to shut off power within a home can be placed at risk of electrocution or burning because of a meter that has been tampered with and that remains live.

Many states have statutes that identify penalties for criminal damage and theft of electricity. In some areas, utilities are training law enforcement officials so that they can investigate anyone found diverting, bypassing or tampering with electric meters. Some obvious clues of meter tampering include a broken seal or wire on the meter, or any unusual attachment to the meter such as a jumper cable or magnet.

Automatic Meter Reading (AMR) technology has been introduced, in part, to combat the growing problem of electricity theft. AMR meters can detect some types of tampering automatically and can help utilities to diagnose other types of theft from detailed patterns of electricity use. The AMR meters are solid state and replace conventional meters with dials and wheels. An AMR module in the meter enables utilities to get meter information from a central station or from a truck using wireless (RFID) technology. The key to widespread use of AMR meters is the ability to detect tampering remotely. The AMR modules make it possible to detect if someone has tried to use magnets or other technology to rig the meter, but harder to detect other tampering because the meters are physically inspected infrequently.

There is a need at every utility for a revenue protection program that tracks the theft of electricity or other resources and recovers lost revenue from those who are liable for the thefts. Although utilities recognize the problem of energy theft, until the present invention there has not been a methodology that manages and tracks investigations, recovery, and prosecution of cases of energy theft.

### SUMMARY OF THE INVENTION

The present invention is directed to a revenue protection case management system designed to track information related to electricity theft and related forms of revenue loss for the electric power industry. The invention handles tracking of information related to the investigation, research, and tracking of such cases in order to collect lost revenue, support prosecution in a court of law, and prevent future losses. The inventive system works across multiple operating companies in order to share data and track suspects as they physically move to new areas. The inventive system can interface to related customer systems to share information.

The present invention makes the revenue protection function within an electric utility more effective. It does so by centralizing information on electricity theft, which allows for rollups of data, easy data accessibility from the field, shared data between different geographic, operations and organizational areas, and a document trail to support litigation.

The invention requires specific data fields in order to track electric current diversion. These data fields include potential transformer installation, current transformer installation, jumper installation, methods of operation, meter multipliers/constants, kilowatt-hours diverted, annualized revenue and aliases.

The invention user interface includes an application homepage that displays up to 20 most recently user-viewed cases with fields for case number, high level condition (diversion, fraud, etc.), operating center, location associated with the case, the investigator and the case status. The user can select any case number to navigate to the case detail screen. The case detail user interface includes links to various functional areas, such as account information, people, cost, legal and attachments. A case information screen can also be reached from the case detail page. The case information display includes a condition found section in which the user can enter the condition of a socket seal, meter socket, master seal, meter, etc. for tracking diversion. The user interface further includes a cost/recovery page to record cost/recovery information for a case. A user interface for legal action enables the user to input legal information through a plurality of check boxes including a case disposition/restitution check box. The invention further includes a user interface for selecting reports from a list of reports. The selectable reports include condition reports by operating company or region/division, investigator or region/division efficiency reports, and status reports by operating company or region.

In one aspect of the invention, a method is provided for managing energy diversion investigations. The method includes the steps of identifying an energy diversion case and entering case information into an energy diversion investigation application; automatically accumulating the data entered into the application and storing the accumulated data in an energy diversion investigations database; generating an energy diversion case file in the energy diversion investigation application; investigating the energy diversion case and reporting a status of the case; updating the energy diversion case file in the energy diversion investigation application; and calculating a cost and a recovery associated with the energy diversion case.

In another aspect of the invention, a system is provided for managing energy diversion investigations. The system includes a case entry user interface component for entering energy diversion case information into a new case file; an energy diversion investigations database for storing energy diversion case information including updates entered by a case investigator; a user interface for updating a status of an energy diversion case; and a revenue protection component for determining a cost and a recovery amount associated with the energy diversion case.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates the processing logic for the data entry function of the diversion investigation management system (DIMS) in accordance with an exemplary embodiment of the invention.

FIG. 2 illustrates processing logic for the query and reporting function of the diversion investigation management system in accordance with an exemplary embodiment of the invention.

FIG. 3 illustrates an exemplary DIMS application homepage.

FIG. 4 illustrates an exemplary case detail screen.

FIG. 5 illustrates an exemplary account information display.

FIG. 6 illustrates an exemplary people, attachments, cost recovery and legal page.

FIG. 7 illustrates an exemplary Case Information data entry display.

FIG. 8 illustrates an exemplary Account Information data entry display.

FIG. 9 illustrates an exemplary Relationship to Case data entry display.

FIG. 10 illustrates an exemplary Add New Person data entry display.

FIG. 11 illustrates an exemplary search page for finding people involved with a case.

FIG. 12 illustrates an exemplary user interface for attaching a file to a case.

FIG. 13 illustrates an exemplary page for associating documents to a case that are too large to upload.

FIG. 14 illustrates an exemplary page to record cost/recovery information for a case.

FIG. 15 illustrates an exemplary legal action page to input legal information and disposition for a case.

FIGS. 16A-16D illustrate exemplary share and search pages that enable the user to identify a user and share a specific case with the user.

FIG. 17 illustrates an exemplary basic search display for performing basic searches on cases.

FIG. 18 illustrates an exemplary advanced search display for performing advanced searches on cases.

FIG. 19 illustrates an exemplary Case History page.

FIG. 20 illustrates an exemplary Reports page.

FIG. 21 illustrates an exemplary selection criteria to limit the search for the report.

FIG. 22 illustrates an exemplary full case printout available from the DIMS application.

FIGS. 23-31 illustrate various standard management reports that can be displayed by selection of the corresponding report link on the Reports page.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

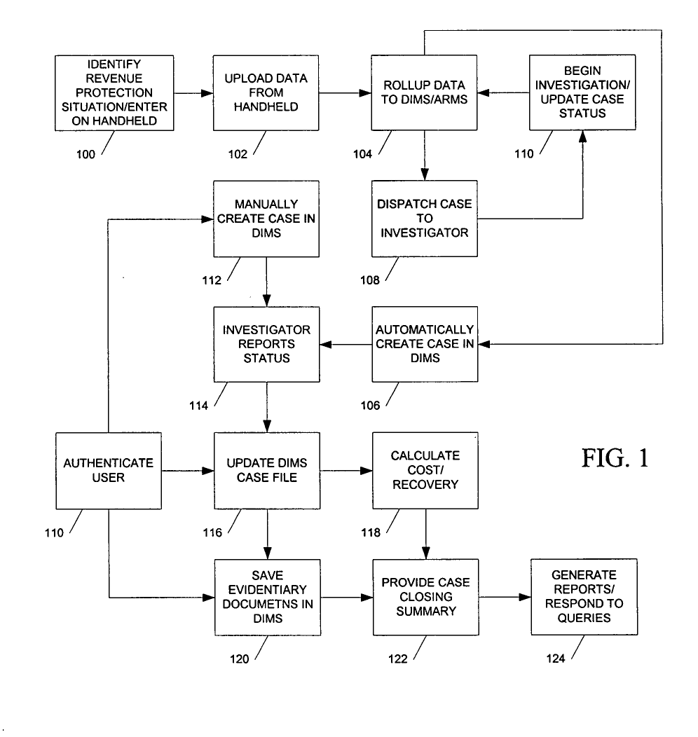

FIG. 1 illustrates exemplary processing logic for the data entry function of the diversion investigation management system (DIMS). In logic block 100, a utility field service representative identifies a special condition of revenue protection and enters the data into a handheld device. This task is performed by multiple utility field service representatives in different locations. The utility field service representative uploads the data from the handheld device to a customer service system (CSS) on a daily basis. This step is indicated by logic block 102. An automated job runs in the customer service system to send rollup data to an automated resource management system (ARMS) for investigator dispatch and to the diversion investigation management system for revenue protection tracking in logic block 104. The data fields can include, but are not limited to, customer name, account number, address, social security number, service order number, reporting employee comments, premise number, meter number, order entry date and type, meter kilowatt hour usage reading and account status. Each dataset transferred to DIMS either creates a new case or updates an existing case. In an exemplary embodiment, updates could occur every four hours. This step is shown in logic block 106.

In ARMS, a dispatcher screens the case and assigns it to an investigator as shown in logic block 108. Once the case is assigned to an investigator, it is dispatched wirelessly to the investigator's truck. The investigator then begins his investigation as indicated in logic block 110. The investigator updates the case in ARMS, which in turn updates the customer service system wirelessly to complete the order in CSS.

The investigator reports findings and case status to a back office support representative as indicated in logic block 114. The data can include any changes to previous CSS data and a summary of investigative efforts and findings. The DIMS case file is then updated with new information by the back office staff as indicated in logic block 116. The entries are date-stamped for a permanent record of the investigation.

A case can also be created in DIMS manually by the field service representative. The DIMS user logs onto the application with secure access control that authenticates the user. This step is indicated in logic block 110. The DIMS system determines the appropriate individual rights, group rights and tool functionality control. The field service representative manually creates a new case in DIMS based upon an observed special condition of revenue protection as indicated in logic block 112. The investigator reports status (logic block 114) and the DIMS case file is updated (logic block 116) as is done with the automatically created DIMS case. The investigator saves or links evidentiary documents in DIMS as required. This can include photos, scanned police reports and crime lab reports among other documents. This step is indicated in logic block 120.

The back office staff performs cost recovery calculations and bill calculations using the CSS and manually enters the resulting data into both CSS and DIMS as indicated in logic block 118. When the case is completed, the investigator enters closing and summary information into DIMS to close the case as indicated in logic block 122. When the case is completed, the back office staff prints a complete case record and files the case record for future reference. The online case data is available for queries and reports after the case is closed. This step is indicated in logic block 124.

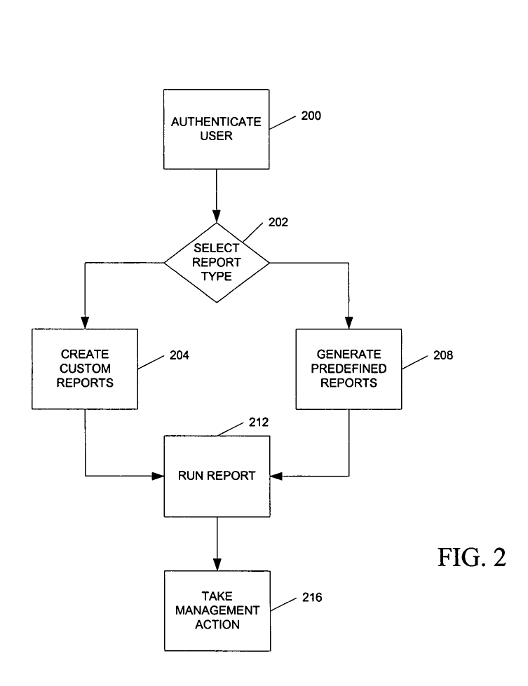

FIG. 2 illustrates exemplary processing logic for the query and reporting function of the diversion investigation management system. In logic block 200, the DIMS user logs onto the application with secure access control that authenticates the user. The DIMS system determines the appropriate individual rights, group rights and tool functionality control. The user decides on either a custom report or a predefined report in decision block 202. The user can either create custom reports as indicated in logic block 204 or generate predefined reports as indicated in logic block 208.

The authenticated user can enter parameters on the user interface screen to create a custom report in logic block 204. A number of options are available to the user to create a custom report. These options include: (1) time range; (2) investigator name; (3) company name; (4) report output format; (5) case status; (6) cases resulting in arrests; (7) cases with unsafe conditions; (8) customer class; (9) dollar thresholds for cost or recovery; (10) geographic regions; and (11) operating centers. Case status can include diversion, non-diversion, closed and collected, closed and solved, closed and unsolved, payment arrangements made, and referred to collections. Other status conditions are possible and included within the scope of the invention. The customer class can include residential, commercial or industrial.

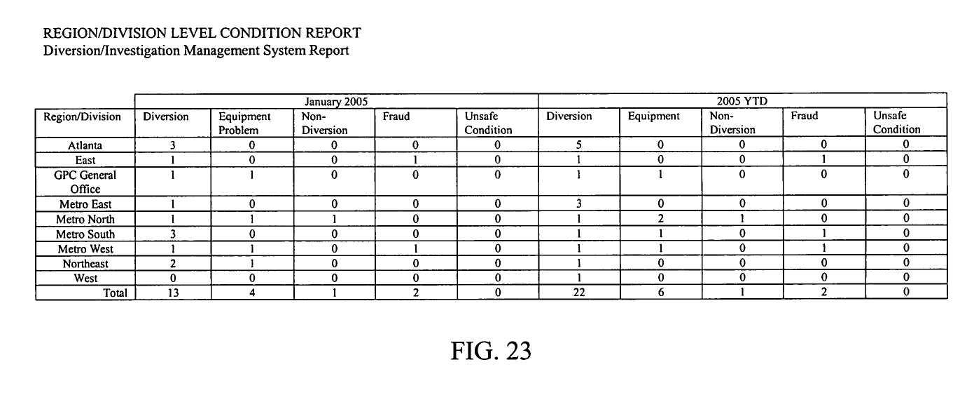

The authenticated user can choose one of a number of pre-defined reports in logic block 208. Examples of pre-defined reports can include, but are not limited to, company efficiency report, region efficiency report, investigator efficiency report, operating center efficiency report and rewards report. Examples of predefined reports are shown in FIGS. 23-31.

Once the user selects the report type and contents, the report is run as indicated in logic block 212. The reports can be output to an Adobe Acrobat PDF file or equivalent, a Microsoft Excel file or equivalent; a printer or the user's display. Utility business management can then use the report for various purposes including business decisions, Sarbanes Oxley compliance, historical analysis and trending and intra-company communications.

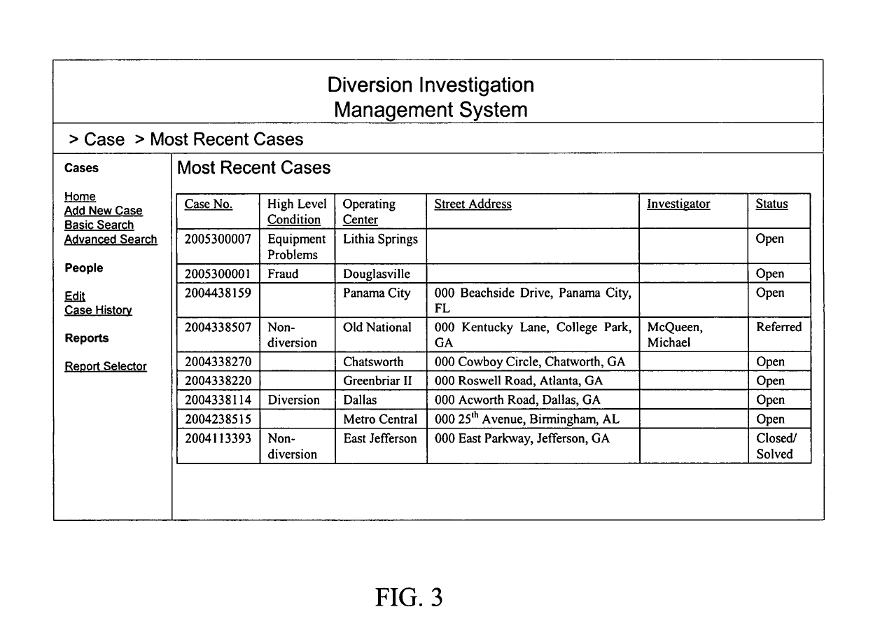

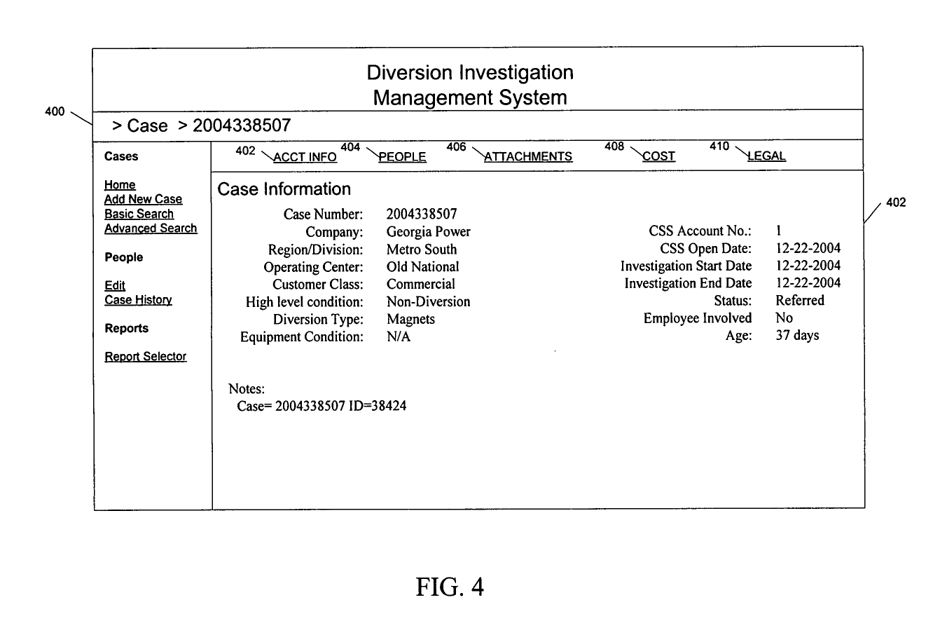

Exemplary DIMS user interface screens are illustrated in FIGS. 3-21. Each exemplary user interface screen in DIMS includes two standard items: a header and a navigation panel. The header contains navigational links for logout, a brief description of the page the user is on and a case number if a case has been selected by the user. The navigation panel is located on the left side of the user interface screen and contains links to functionality pages that the user can access. FIG. 3 illustrates an exemplary header 300 and navigation panel 310. Navigation panel 310 has three major headings: Cases, People and Reports. Under the Cases heading, the user can select Home, Add New Case, Basic Search or Advanced Search. Selecting Home takes the user to the landing page where most cases are displayed as shown in FIG. 3. Selecting Add New Case navigates the user to the Case Information screen, an example of which is depicted in FIG. 4. Under the People heading, the user can select edit or case history. Either selection will take the user to the People user interface screen. Below the Reports heading is a Report Selector link that navigates the user to the Report List page discussed below.

FIG. 3 illustrates an exemplary DIMS application homepage. This page displays the most recent cases 320 that the user has viewed. In one embodiment, the last 20 cases viewed by the user are displayed. The user can select any of the headings in window 320 to sort the list displayed by the selected heading. In the embodiment depicted, the headings include case number, high level condition, operating center, street address, investigator and case status. The user can select any case number displayed to navigate to the corresponding case detail screen for that case.

FIG. 4 illustrates an exemplary case detail screen. The case number is displayed in the header section 400 of the page. Most of the information displayed on this screen is read only. However, and Edit link is available for each functional section enabling the user to edit that section of data on the case information screen. The case detail screen has several functional areas including account information, people, attachments, cost and legal. The user can navigate to each functional area on the page by selecting a corresponding link 402-410 above the case information window 420.

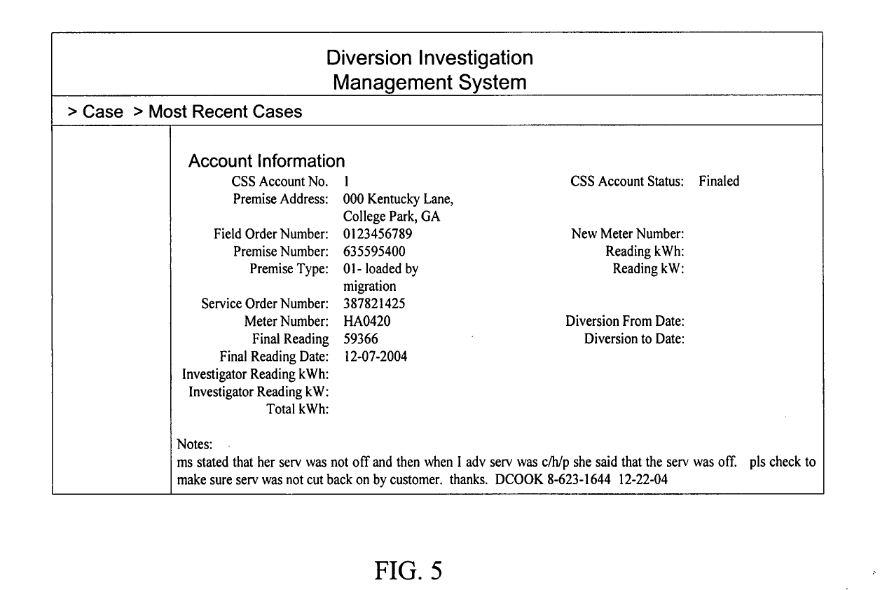

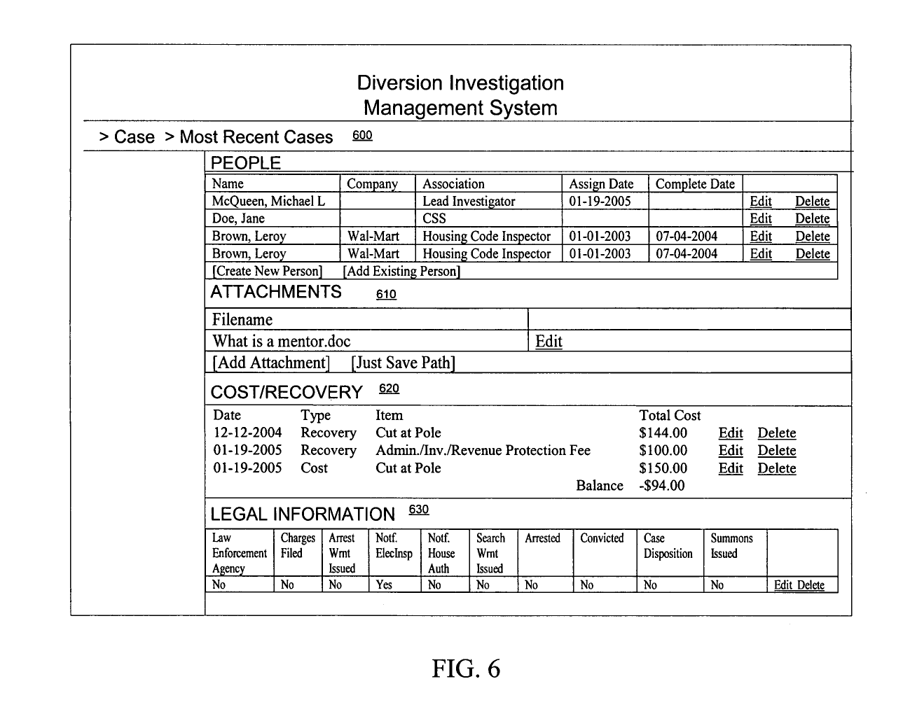

Selecting the account information link 402 on the case detail page will navigate the user to an account information page where the account information for the selected case is displayed. An edit link on this display navigates the user to an account information page where the data can be modified. An exemplary account information display is depicted in FIG. 5. Selecting people link 404, attachments link 406, cost link 408 or legal link 410 on the case detail page will navigate the user to a people, attachments, cost recovery and legal page. An exemplary people, attachments, cost recovery and legal page is illustrated in FIG. 6.

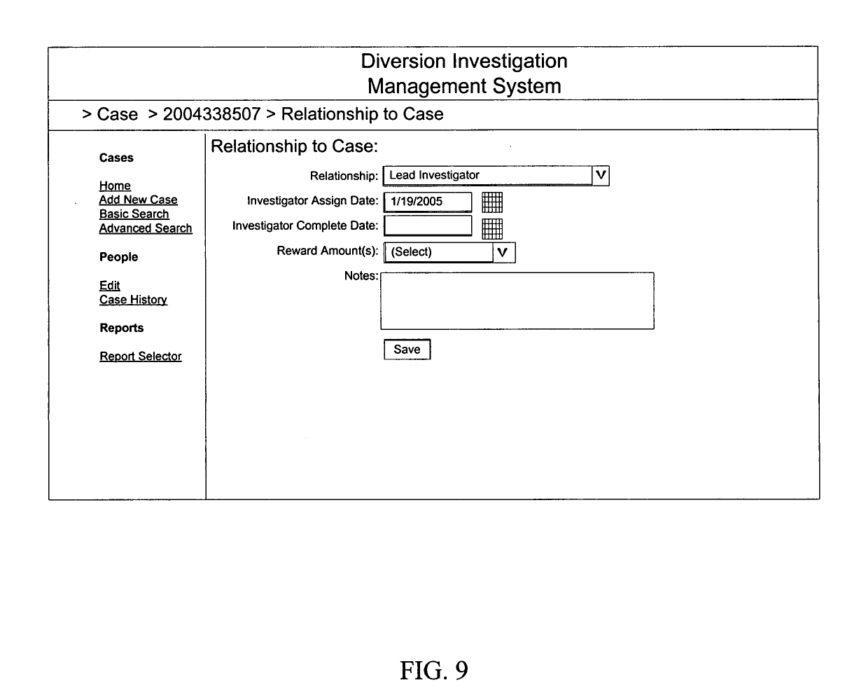

In people section 600, selecting the edit link adjacent to a person's name will forward the user to the relationship to case page illustrated in FIG. 9 where the person's relationship to the case information can be modified. The delete link will enable the user to disassociate a person from the case. The create new person and add existing person links will navigate the user to the person detail page and the people screen, respectively. In the attachments section 610, the user can select edit adjacent to a document name to open the document for editing. Selecting the Add Attachment link navigates the user to the attach file to case screen. Selecting the Just Save Path link forwards the user to the Save File Path to Case screen. The cost/recovery section 620 enables the user to edit or delete a cost recovery item. The edit link will take the user to the Cost page where cost information can be modified. An Add Cost Item link is also provided in this section and enables the user to add a new cost item. The legal section 630 enables the user to edit or delete a legal item from the case. Selecting the edit link navigates the user to a legal page where legal information can be modified.

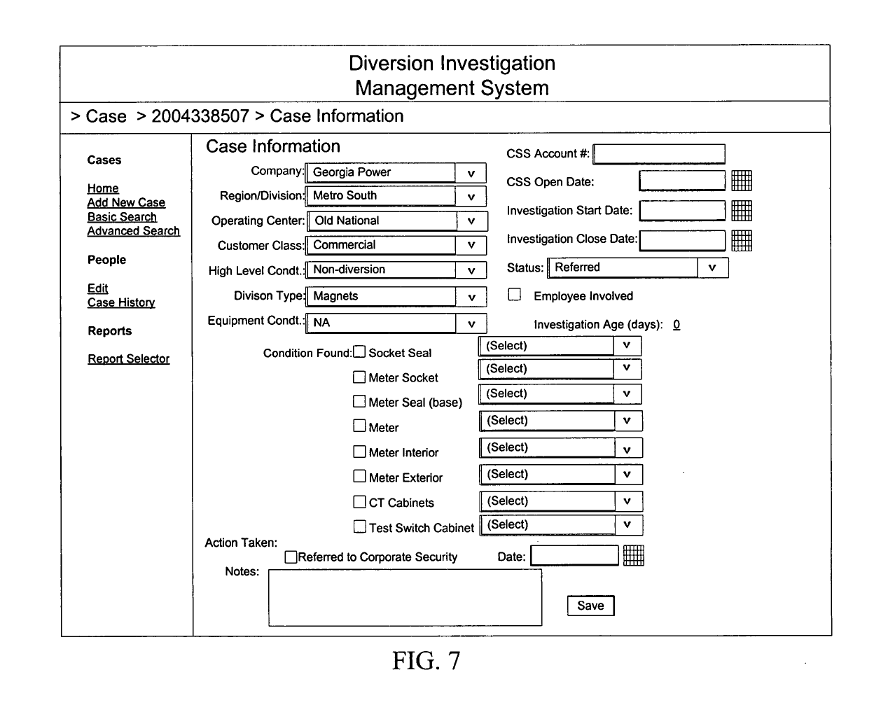

FIG. 7 illustrates an exemplary Case Information data entry display. The user can navigate to this screen from the Case Detail screen depicted in FIG. 4 or by selecting Add New Case on the navigation panel. When the user enters information on this display, several of the fields are changed dynamically based on user input. If the Company dropdown is changed, the Region/Division dropdown is populated based on the Company selection. If the Region/Division dropdown is changed, the Operating Center dropdown is populated based on the Region/Division selection. If the High Level Condition dropdown is changed to “Diversion” the Diversion dropdown is populated. If Equipment Condition is selected, the Equipment Condition dropdown is populated. If any of the Condition Found choices are selected, the adjacent dropdown box is populated with relevant data. The User can enter CSS Open Date, Investigation Start Date and Investigation Close Date in the corresponding data fields on this display.

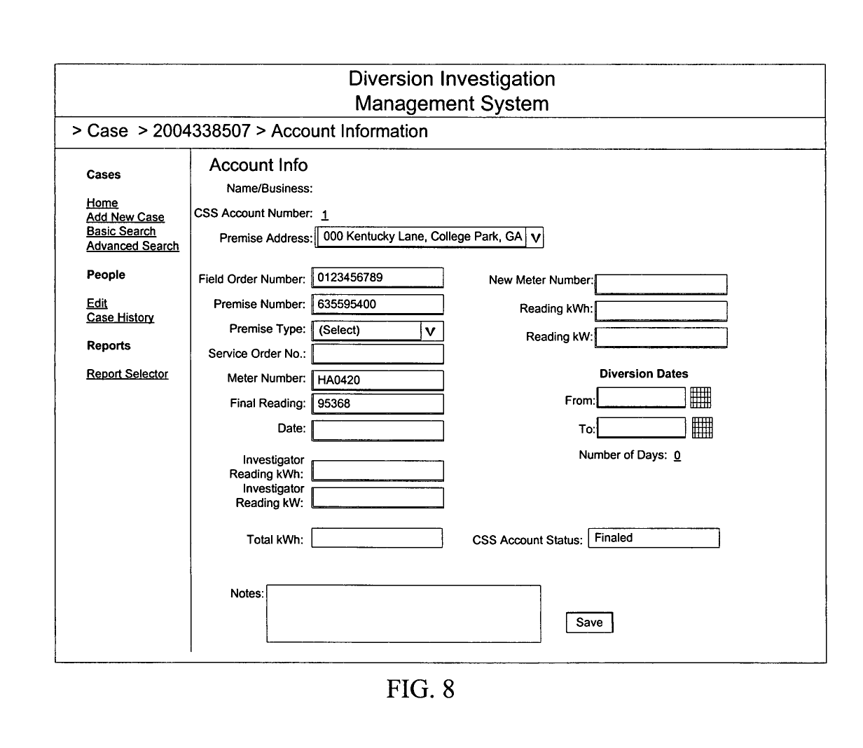

FIG. 8 illustrates an exemplary Account Information data entry display. Most of the information on this display is populated directly from the CSS system. If data displayed is updated by the user, the changed information is updated in the DIMS system. Diversion start and end dates are also entered on this display.

FIG. 9 illustrates an exemplary Relationship to Case data entry display. In particular, this screen associates a person with a case. The user can navigate to this page by selecting the edit link on the case detail page adjacent to a person's name, or by selecting the Add New Case link on the navigation panel. This display contains fields for entry of a relationship (e.g., lead investigator), an investigator assignment date and an investigator completion date.

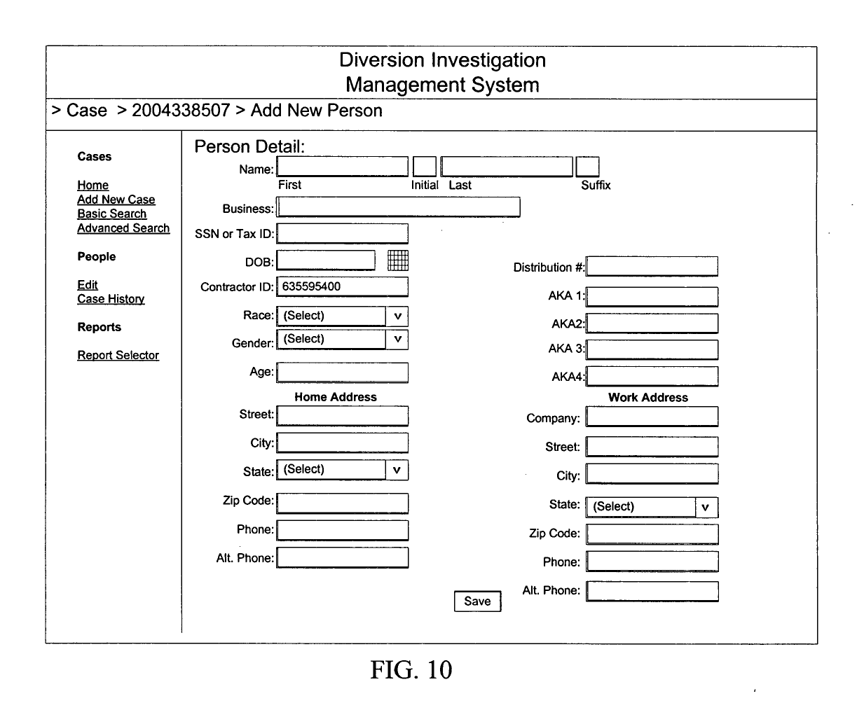

FIG. 10 illustrates an exemplary Add New Person data entry display. The user can navigate to this page by selecting the Create New Person link on the Case Detail page or by selecting the person's name from the People page. The information entered on this data entry screen is self-explanatory.

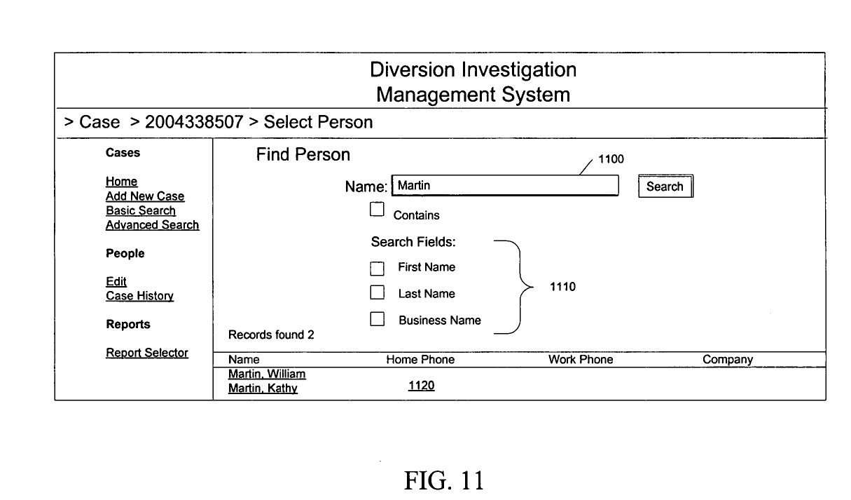

FIG. 11 illustrates an exemplary Select Person search page. A person's last name, first name, business name, or a portion of any of these is entered into the name box 1100. The user enters search criteria in section 1110 of the display, and selects search. The system returns the records found in section 1120 of the display. Selecting a record will direct the user to the Add New Person display of FIG. 10.

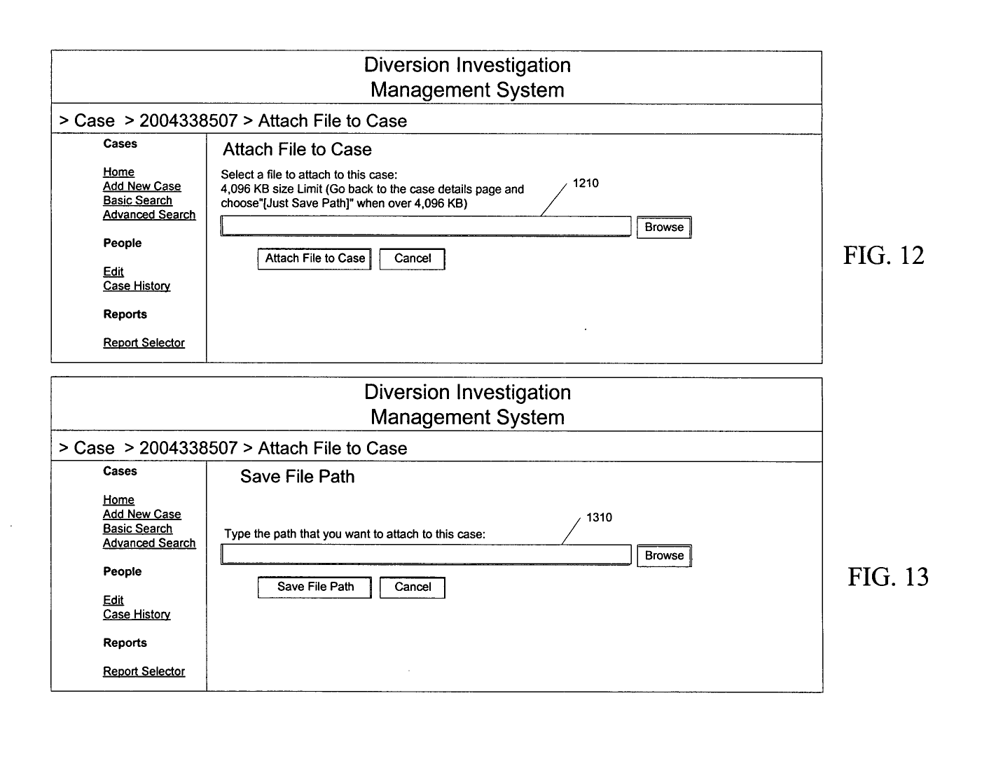

FIG. 12 illustrates an exemplary user interface for attaching a file to a case. The user can enter the direct path on his local machine in the textbox 1210, or can click the browse button to browse for the file. When the file is located, the user selects “Attach File to Case.” After the document is uploaded successfully, the user is directed to the Case Detail page of FIG. 4 with the document displayed in the list.

FIG. 13 illustrates an exemplary page for associating documents to a case that are too large to upload. In an exemplary embodiment, the file is saved to a shared drive that everyone with access to the system can view. The user enters the path to the file in the textbox 1310 and selects “Save File Path.” After the path is uploaded successfully, the user is returned to the Case Detail page of FIG. 4 with the document displayed in the list.

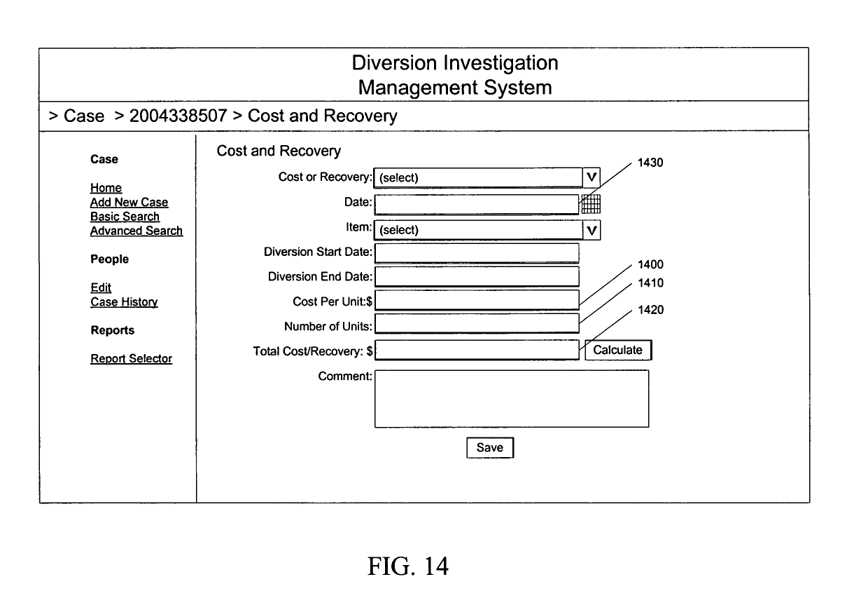

FIG. 14 illustrates an exemplary page to record cost/recovery information for a case. The user can enter data in the cost per unit 1400 and number of units 1410 fields to calculate total cost/recovery, or can input the total cost/recovery directly in filed 1420. The date entered in field 1430 is the date of the cost/recovery, not the date of the case itself.

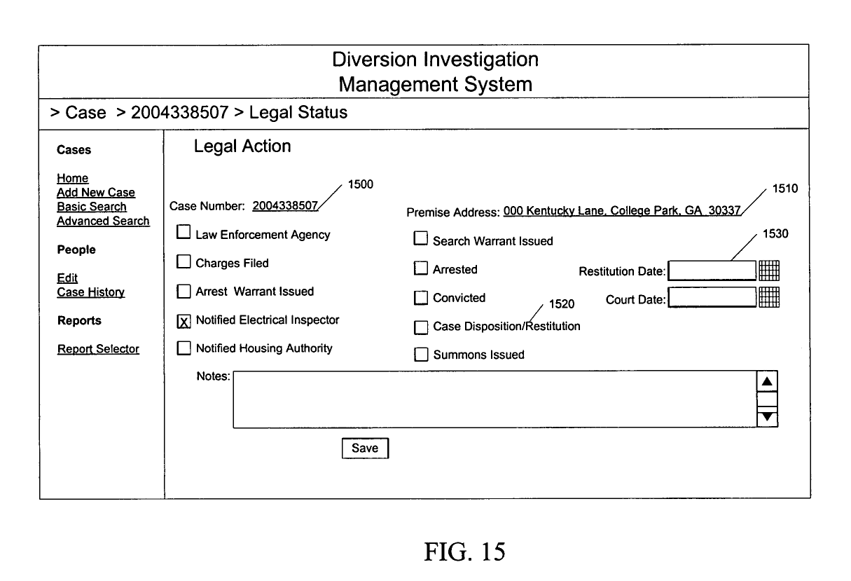

FIG. 15 illustrates an exemplary legal action page to input legal information and disposition. The case number 1500 and premises address 1510 are read only fields. Selecting the case disposition/restitution checkbox 1520 will cause the restitution date field 1530 to become active. This exemplary page is used to provide a current status of law enforcement and legal action for a specific case of energy diversion. Checkboxes include law enforcement agency, search warrant issued, charges filed, arrested, convicted, etc.

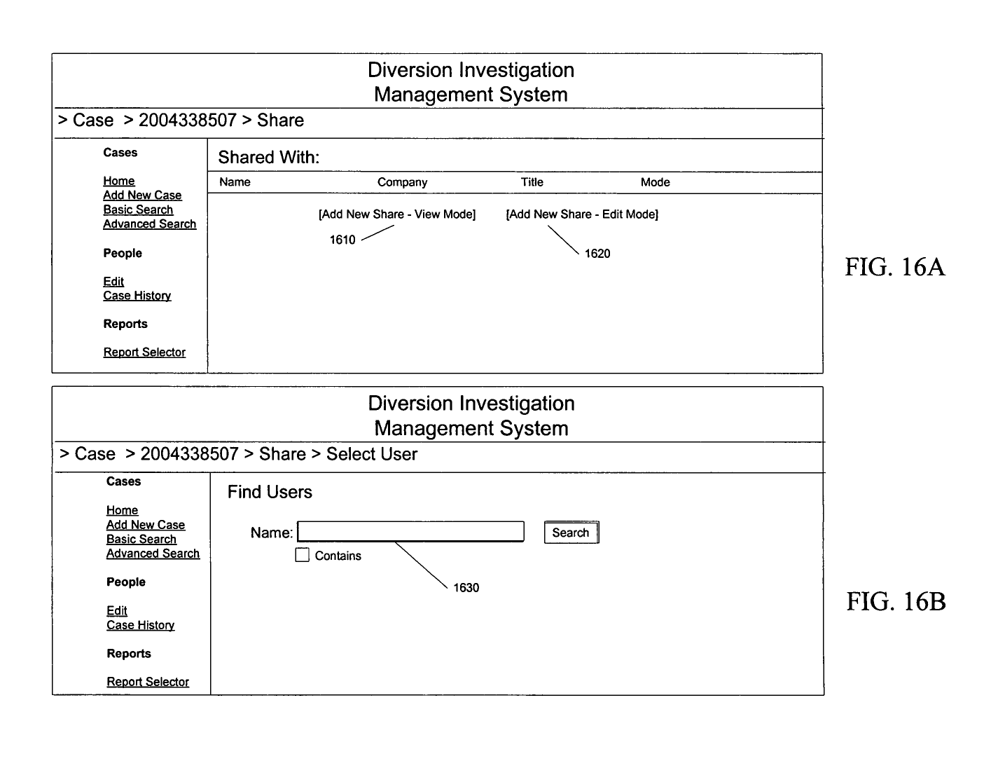

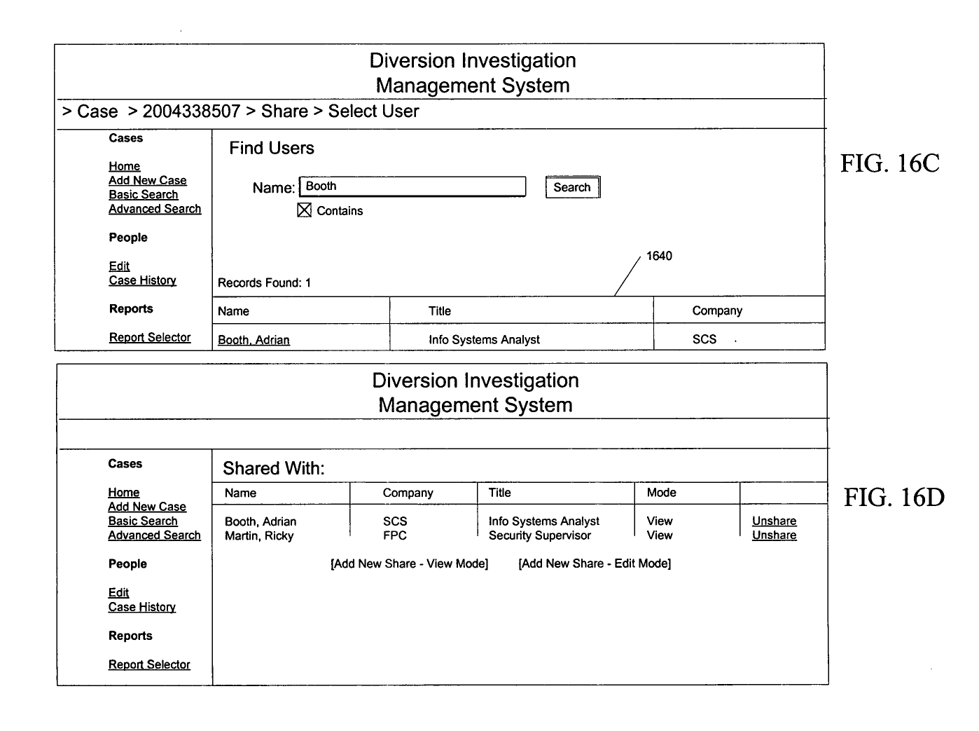

FIG. 16A illustrates an exemplary share page that enables the user to share a specific case with another user that may not have security privileges to access the case. The user can select Add New Share—View Mode 1610 or Add New Share—Edit Mode 1620. The page depicted in FIG. 16B is then displayed in order for the user to enter a name to search for in textbox 1630 and then start a search. The results of the search are returned to this page in field 1640 as illustrated in FIG. 16C. By selecting a name in field 1640, the user is returned to the share page display shown in FIG. 16D in which the person's name is displayed with appropriate security credentials.

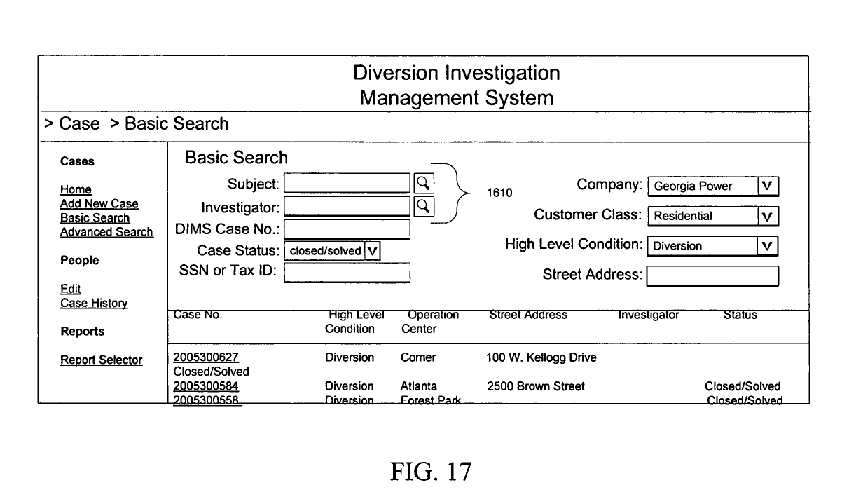

FIG. 17 illustrates an exemplary basic search display that is accessible from the left navigation panel by selecting “Basic Search.” The user can enter search criteria on this page to perform basic searches for cases. Criteria are entered by making selections from the dropdown boxes 1600, entering data directly, and using the search controls that are displayed in a popup window when either of the looking glasses 1610 is selected. A list of cases matching the search criteria is displayed on the bottom of the page. Selecting the case number for any case displayed will direct the user to the Case Detail page of FIG. 4.

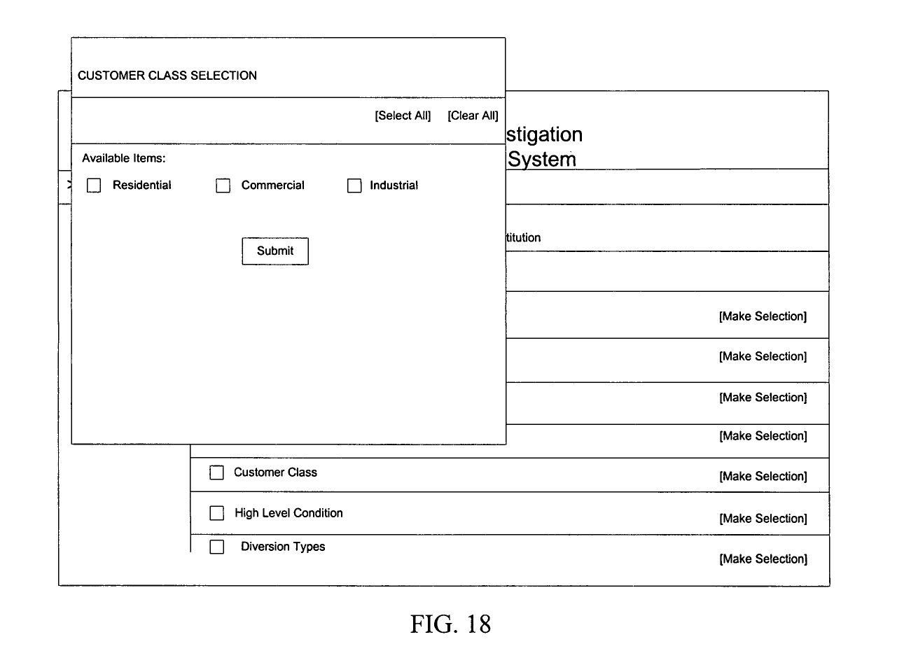

FIG. 18 illustrates an exemplary advanced search display that is accessible from the left navigation panel by selecting “Advanced Search.” The user selects the search criteria and selects the Make Selection link. A popup window displays that enables the user to enter additional search criteria. A list of cases matching the search criteria is displayed on the bottom of the page.

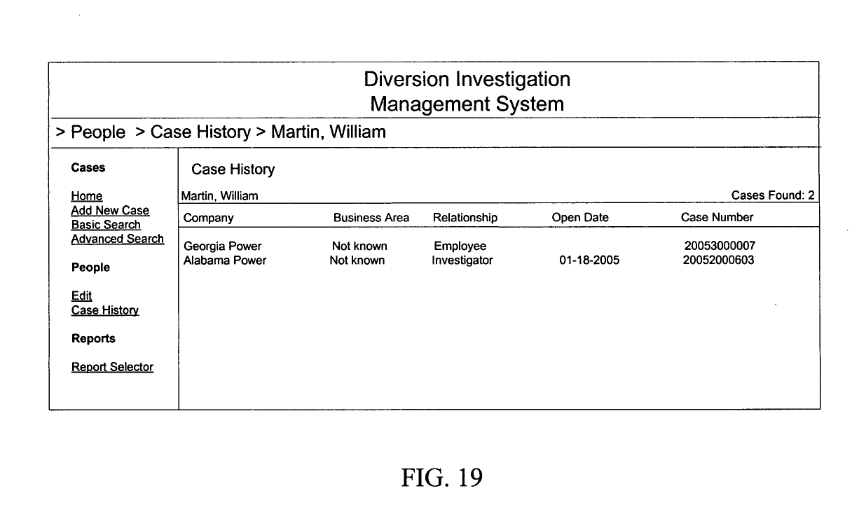

FIG. 19 illustrates an exemplary Case History page that can be reached by selecting “Case History” from the left navigation panel. The user is first directed to the People page to search for the person for whom the case history is needed. After the search is performed, the display of FIG. 19 is presented. All the fields on the display are read only.

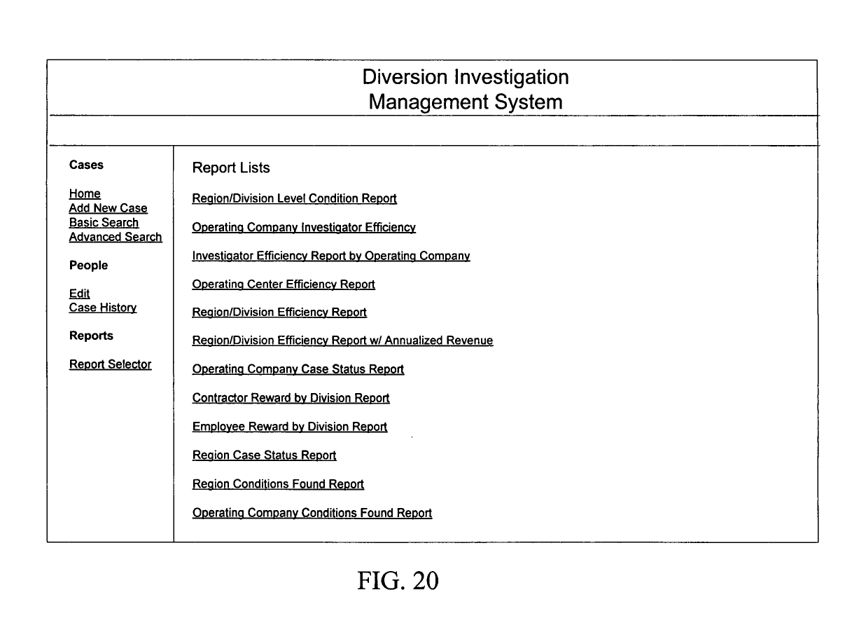

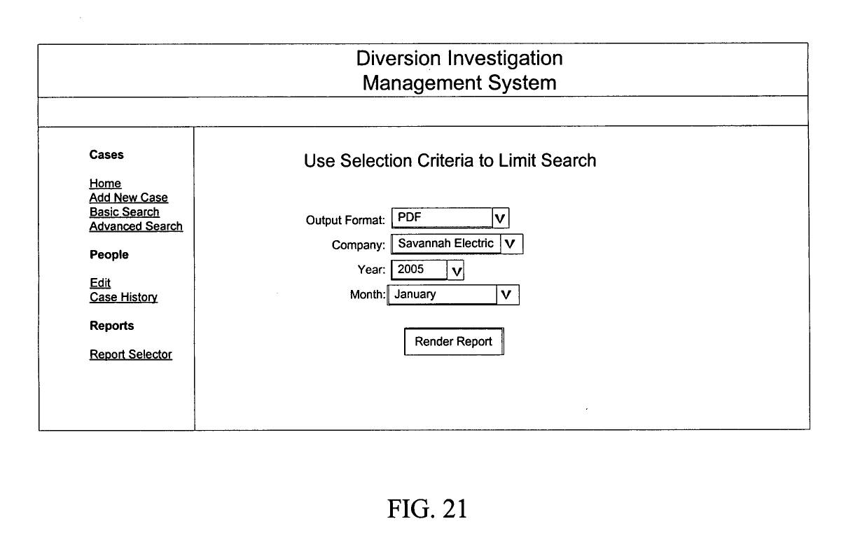

FIG. 20 illustrates an exemplary Reports page that can be reached by selecting the “Report Selector” link in the left navigation panel. After the use selects a report from the displayed list, he will be asked for specific criteria for the report as shown in FIG. 21. The exemplary selection criteria for the search depicted in FIG. 21 are output format (e.g., PDF), company name, year and month for the report. Selecting “Render Report” will cause the generation of the report according to the search criteria entered.

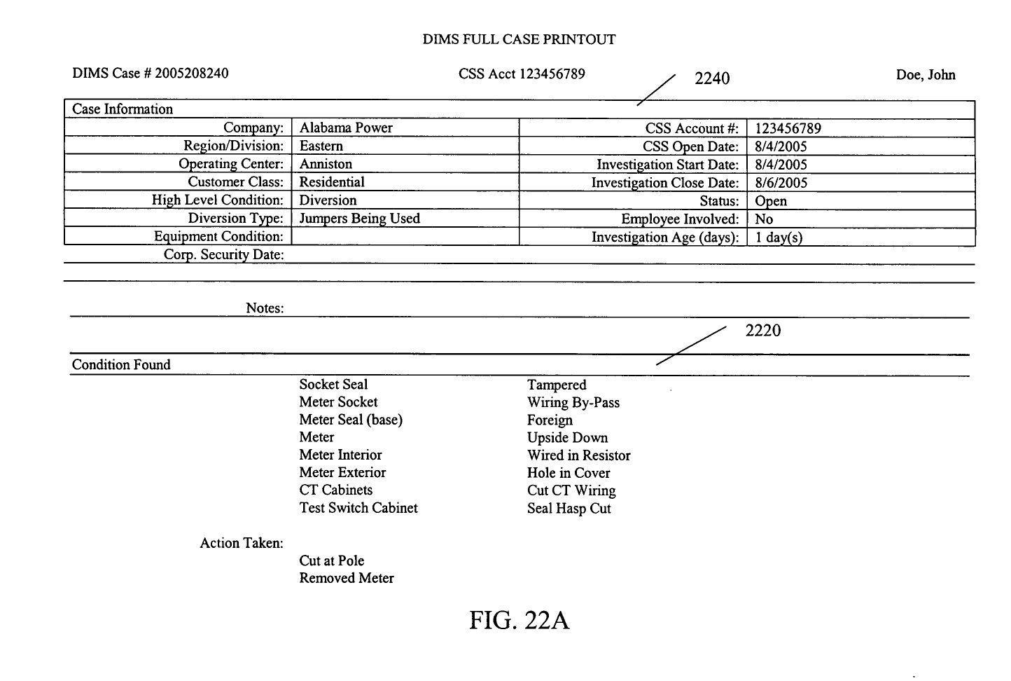

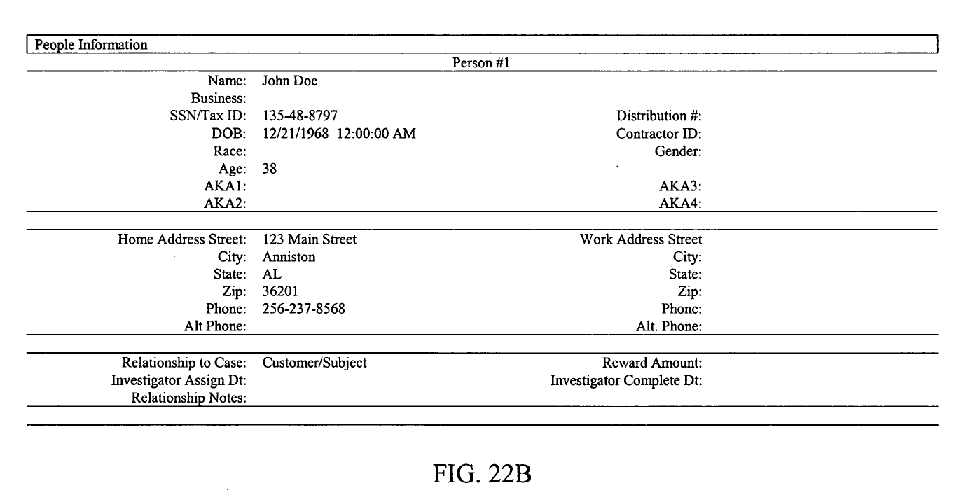

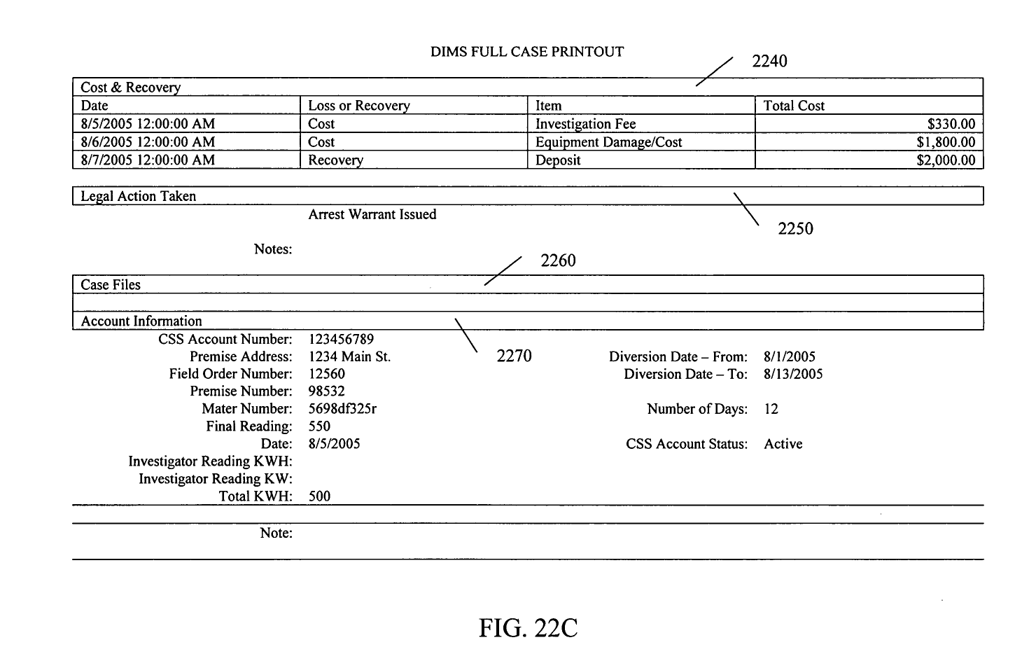

FIG. 22 illustrates an exemplary full case printout available from the DIMS application. The parts of the full case report can include case information section 2210, conditions found section 2220, people information section 2230, cost and recovery section 2240, legal action section 2250, case files section 2260 and account information section 2270.

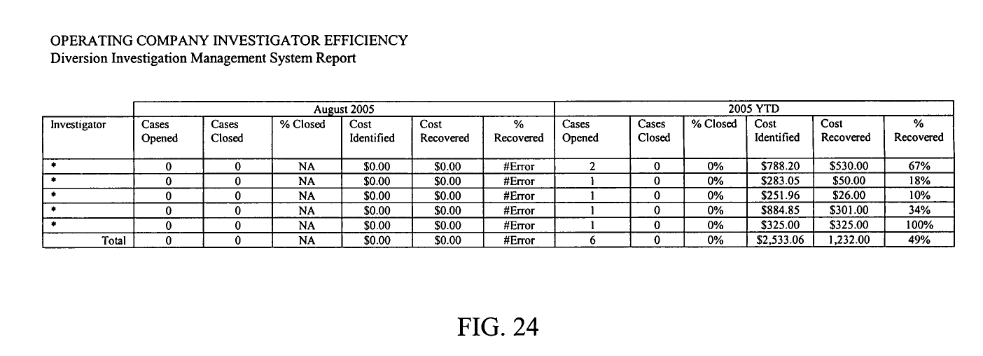

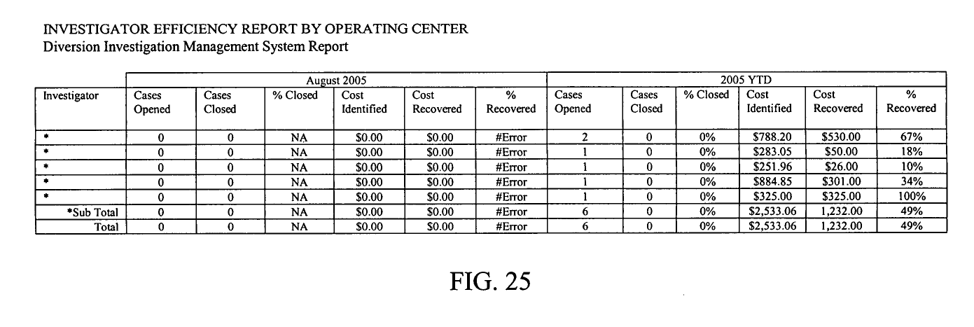

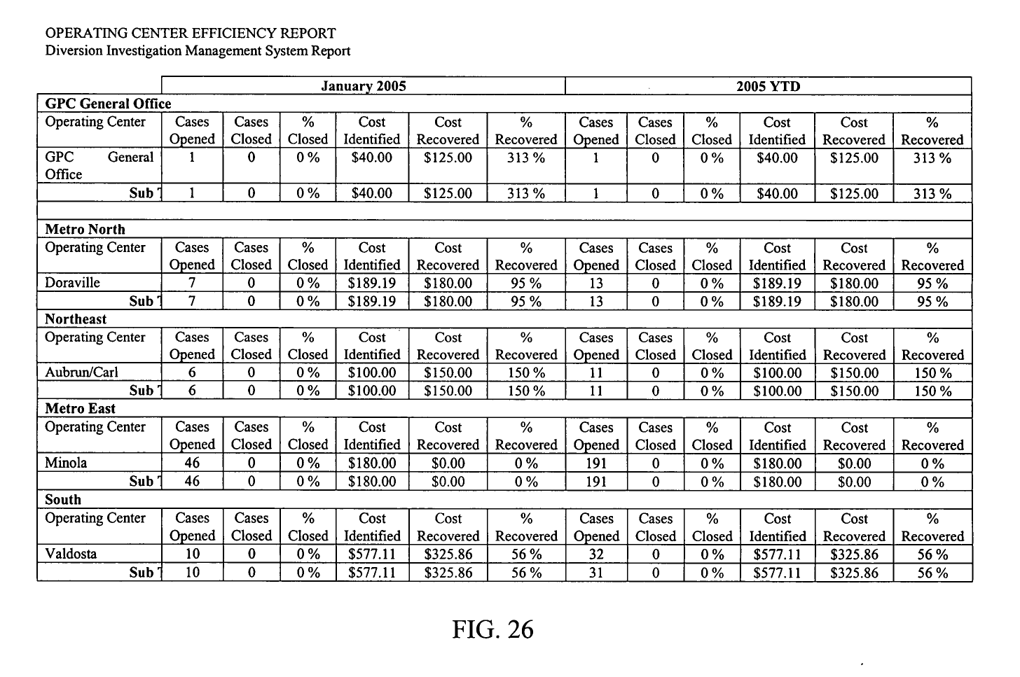

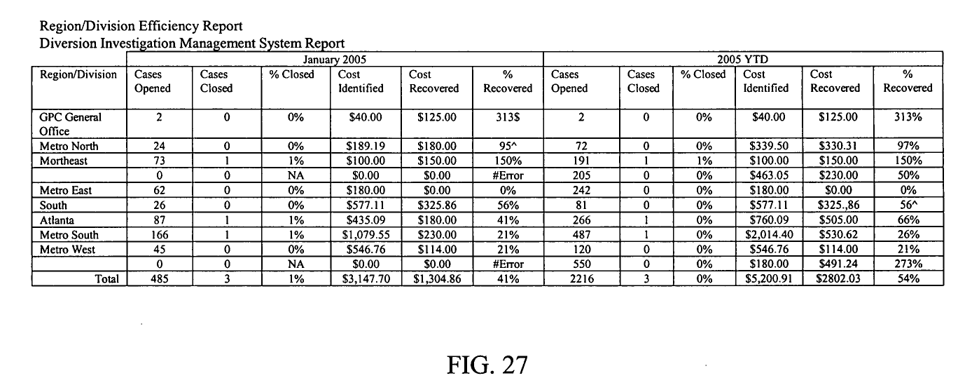

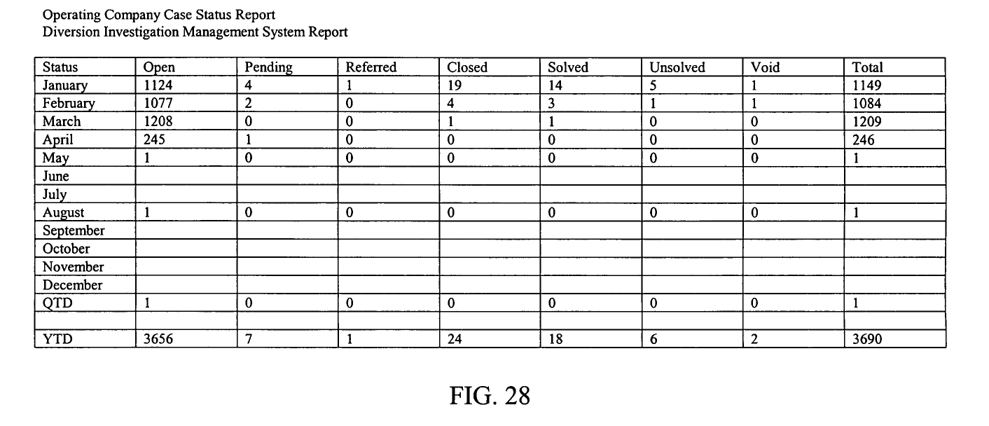

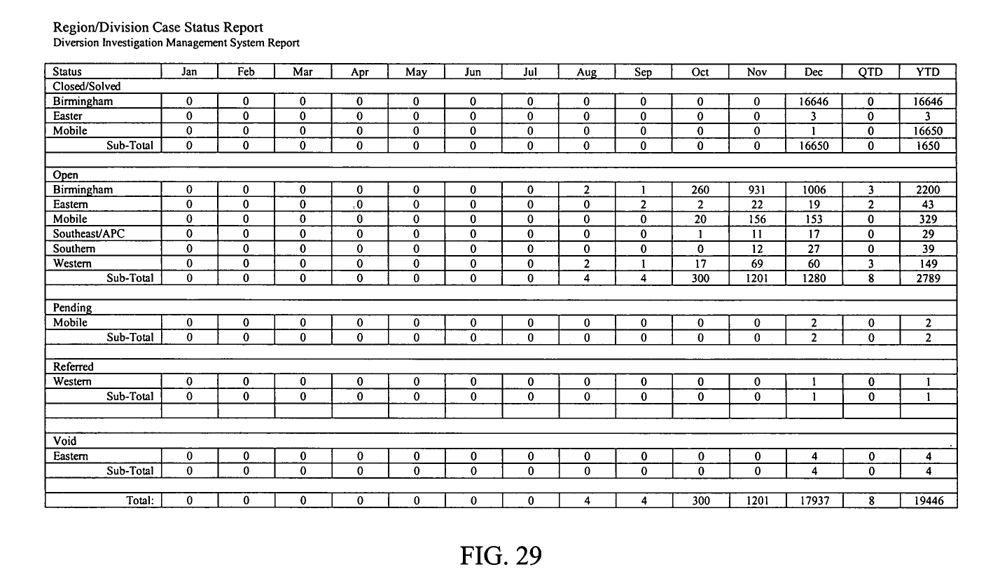

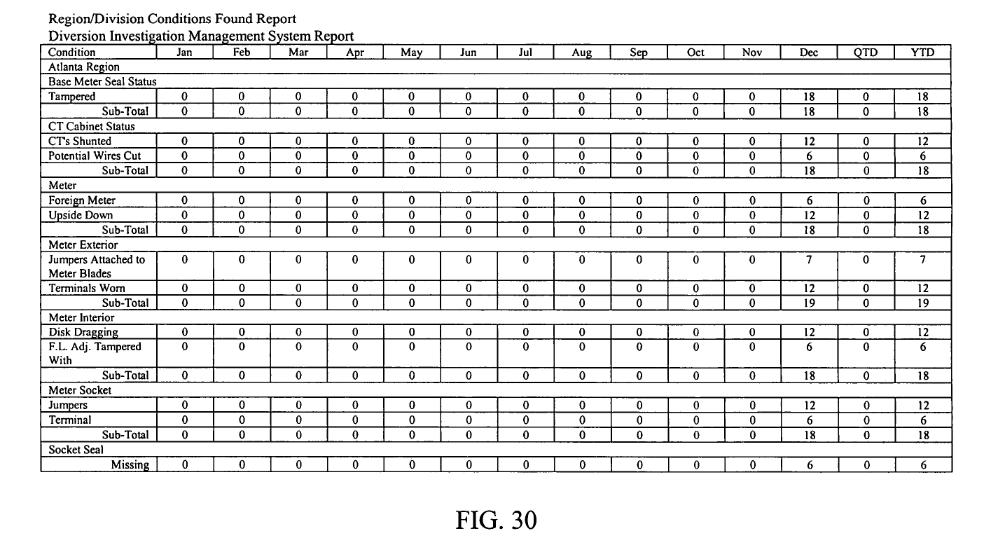

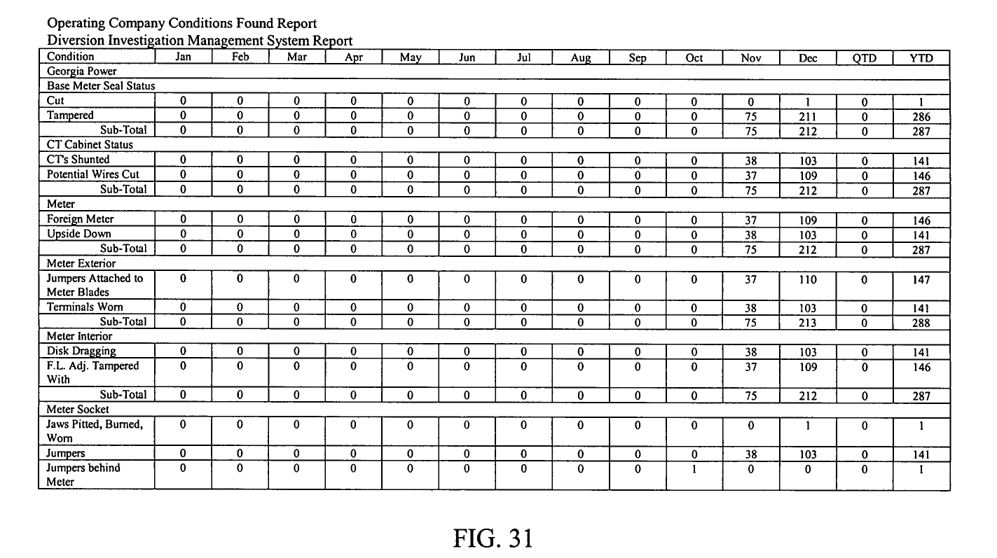

Examples of predefined reports are depicted in FIGS. 23-31. An exemplary diversion/condition report by region and division level is shown in FIG. 23. An exemplary investigator efficiency report by operating company is shown in FIG. 24. An exemplary investigator efficiency report by operating center is shown in FIG. 25. An exemplary efficiency report by operating center is shown in FIG. 26. An exemplary efficiency report by region/division is shown in FIG. 27. An exemplary case status report by operating company is shown in FIG. 28. An exemplary case status report by region/division is shown in FIG. 29. An exemplary conditions found report by region/division is shown in FIG. 30. An exemplary conditions found report by operating company is shown in FIG. 31.

Management actions that can be taken as a result of use of the various standard reports in DIMS reports fall into four categories: staffing, compliance, communication, and theft reduction. The following paragraphs provide examples from each category.

Standard DIMS reports can be used for staff management planning, staff performance management and training purposes:
1. Staff Management Planning—DIMS reports are used to deploy manpower to different areas within the company's service territory based upon need. The reports are used to build a staffing model, which is then used to establish a budget.
2. Staff Performance Management—DIMS reports are used to analyze the productivity and effectiveness of the individual revenue protection employees. The reports provide data that is used in performance reviews.
3. Training—DIMS reports are used to identify repeated patterns of consistent methods of operations for electricity diversion. These consistent patterns are used in developing training plans for investigators and other staff. In particular, any known diversion methods that result in unsafe work conditions are included in the training programs for any staff who may encounter the conditions in the course of normal work. In addition, the DIMS reports can be used to identify the training needs of individual revenue protection staff members.

Standard DIMS reports can be used for Sarbanes-Oxley compliance, tracking and identifying safety problems, and rate setting:
1. Sarbanes-Oxley Compliance—DIMS reports are used to track the treatment of unbilled revenue for Sarbanes-Oxley compliance. They provide management with an auditable history of recovered revenue.
2. Safety Issues—The DIMS reports are used to identify and track safety problems in order for management to ensure employees and customers remain as safe as possible. For example, the reports can be used to identify neighborhoods or specific perpetrators where electricity theft has resulted in threatening or criminal behavior or the use of weapons. In these cases, employees will be asked to take additional precautionary measures before approaching potential thieves (i.e., requesting support from law enforcement).
3. Total Unbilled Revenue—DIMS provides consolidated reports of total unbilled revenue. Management uses these reports to work with the state regulators on setting and managing electricity rates.

Standard DIMS reports can be used for executive briefings, local reporting, and trending analysis:
1. Executive Briefings—DIMS creates summary data roll-up reports that management uses to brief executives at meetings.
2. Local Management Reporting—The centralized revenue protection management uses DIMS to create reports to share with the local management of the various geographic regions within the company. Management uses these reports to understand and address their local current diversion problems.
3. Trending Analysis—DIMS creates reports that show the changes in electricity theft and other forms of current diversion over time. These can be used by management to understand trends and make any needed adjustments in company programs.

Standard DIMS reports can be used for adjusting methods of operation and tracking cases for litigation purposes:
1. Methods of Operation—DIMS reports can group similar types of cases and show methods of operation. Management uses this information to identify new or growing problems areas in order to identify the best areas to focus resources. For example, if a new type of theft is becoming popular, staff training time may be focused on how to best identify and combat it. Also, management may change business processes to take the new theft methodology into account.
2. Litigation Records—DIMS tracks a case history for any incident, location, or individual. This case history can be printed as a report and used as evidence for law enforcement, including litigation. The DIMS reports provide a centralized location to track data and records that management uses in the prosecution of the suspects of revenue protection related cases.

The present invention is not limited to electricity theft and accidental current diversion losses. The concepts are applicable to other utilities that involve metering and billing individual customers, such as natural gas, water and sewer, and cable television.

The diversion investigation management system of the present invention has been described as a computer implemented process. It is important to note, however, that those skilled in the art will appreciate that the mechanisms of the present invention are capable of being distributed as a program product in a variety of forms, and that the present invention applies regardless of the particular type of signal bearing media utilized to carry out the distribution. Examples of signal bearing media include, without limitation, recordable-type media such as diskettes or CD ROMs, and transmission type media such as analog or digital communications links.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed:

1. A method for managing energy diversion investigations comprising the steps of:
identifying an energy diversion case and entering case information into an energy diversion investigation application;
automatically accumulating the data entered into the application and storing the accumulated data in an energy diversion investigations database;
generating an energy diversion case file in the energy diversion investigation application;
investigating the energy diversion case and reporting a status of the case;
updating the energy diversion case file in the energy diversion investigation application; and
determining a cost and a recovery associated with the energy diversion case.

2. The method for managing energy diversion investigations of claim 1 further comprising the steps of generating an evidentiary document and storing the evidentiary document in the database.

3. The method for managing energy diversion investigations of claim 1 further comprising the step of providing a case closing summary.

4. The method for managing energy diversion investigations of claim 1 further comprising the step of generating a custom report.

5. The method for managing energy diversion investigations of claim 1 further comprising the step of generating a predefined report.

6. The method for managing energy diversion investigations of claim 1 further comprising the step of authenticating a user's access to the energy diversion investigation application.

7. The method for managing energy diversion investigations of claim 2 wherein the step of storing an evidentiary document comprises storing at least one of a photograph, a scanned police report or a crime laboratory report.

8. The method for managing energy diversion investigations of claim 1 further comprising the step of dispatching the energy diversion case to an investigator.

9. The method for managing energy diversion investigations of claim 8 wherein the step of dispatching the energy diversion case comprises the steps of screening the energy diversion case and assigning the case to the investigator using an automated resource management system.

10. The method for managing energy diversion investigations of claim 1 wherein the energy diversion case file comprises at least one of case information, condition found information, people involved information, cost and recovery information, legal action information and account information.

11. A system for managing energy diversion investigations comprising:
a case entry user interface component for entering energy diversion case information into a new case file;
an energy diversion investigations database for storing energy diversion case information including updates entered by a case investigator;
a user interface for updating a status of an energy diversion case; and
a revenue protection component for determining a cost and a recovery amount associated with the energy diversion case.

12. The system for managing energy diversion investigations of claim 11 further comprising a component for generating an evidentiary document and storing the evidentiary document in energy diversion investigations database.

13. The system for managing energy diversion investigations of claim 11 further comprising a user interface for entering a case closing summary into the energy diversion case file.

14. The system for managing energy diversion investigations of claim 11 further comprising an output component for generating a custom report.

15. The system for managing energy diversion investigations of claim 11 further comprising an output component for generating a predefined report.

16. The system for managing energy diversion investigations of claim 11 further comprising an authentication component for verifying a user's access rights to energy diversion case information.

17. The system for managing energy diversion investigations of claim 11 further comprising an automated resource management component for dispatching the energy diversion case for investigation.

18. The system for managing energy diversion investigations of claim 17 wherein the automated resource management component comprises a module for screening the energy diversion case and assigning the case to an investigator.

19. The system for managing energy diversion investigations of claim 11 wherein the energy diversion case file comprises at least one of case information, condition found information, people involved information, cost and recovery information, legal action information and account information.

20. A computer program product for managing energy diversion investigations, the computer program product comprising a computer readable medium having computer readable code embedded thereon, the computer readable medium comprising:
program instructions that enable entry of information identifying an energy diversion case;
program instructions that automatically accumulate the data entered and store the accumulated data in an energy diversion investigations database;
program instructions that generate an energy diversion case file;
program instructions that enable entry of investigation information and case status into the energy diversion case file;
program instructions that enable updating the energy diversion case file; and
program instructions that determine a cost and a recovery associated with the energy diversion case.

21. The computer program product of claim 20 further comprising program instructions that enable reading and storage of an evidentiary document pertaining to the energy diversion case.

22. The computer program product of claim 20 further comprising program instructions that enable entry of a case closing summary.

23. The computer program product of claim 20 further comprising program instructions that enable generation of a predefined report.

24. The computer program product of claim 20 further comprising program instructions that enable generation of a custom report.

25. The computer program product of claim 20 further comprising program instructions that authenticate a user's access rights to energy diversion case information.

26. The computer program product of claim 20 further comprising program instructions that enable entry of at least one of case information, condition found information, people involved information, cost and recovery information, legal action information and account information in the energy diversion case file.
